(19) United States
(12) Patent Application Publication
(10) Pub. No.: US 2006/0223589 A1
(43) Pub. Date: Oct. 5, 2006

(54) Communication apparatus and communication program storage medium

(75) Inventors: Naoki Takazawa, Sapporo (JP); Chisara Yamazaki, Sapporo (JP); Tatsuya Hiraishi, Sapporo (JP); Hitoshi Oshino, Sapporo (JP); Mitsunari Ueno, Sapporo (JP); Koichiro Mikami, Sapporo (JP); Toshihiko Sugiyama, Sapporo (JP); Hiroyuki Ito, Sapporo (JP); Hideki Arata, Sapporo (JP); Aya Kimura, Sapporo (JP); Kazutaka Satoh, Sapporo (JP); Masayoshi Hayasaka, Sapporo (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/189,187

(22) Filed: Jul. 26, 2005

(30) Foreign Application Priority Data
Mar. 30, 2005 (JP) 2005-98274

(51) Int. Cl. H04B 1/38

(52) U.S. Cl. 455/564; 455/550.1

(57) ABSTRACT

A communication apparatus which communicates with an external apparatus by receiving a communication request transmitted from the external apparatus based a call-out number uniquely allocated to the communication apparatus, includes: a communication request receiver which receives identification information allocated to the external apparatus and the communication request independently of a call-out number of the external apparatus; a display which displays information; an information storage which stores an association table associating the identification information of the external apparatus with apparatus information used for displaying in reception of the communication request from the external apparatus; and a display controller which, when the communication request receiver receives a communication request with identification information, displays apparatus information recorded in the association table stored in the information storage on the display, which is associated with identification information matching the identification information received with the communication request.

### BACKGROUND OF THE INVENTION

1. Field of the Invention

The present invention relates to a communication apparatus which is called from an opposite apparatus on the basis of a call-out number uniquely allocated to the apparatus to communicate with the opposite apparatus, and a communication program storage medium which stores a communication program executed in an apparatus having a function of executing a program to cause the apparatus to operate as such a communication apparatus.

2. Description of the Related Art

In recent years, persons frequently answer the telephone without knowing a caller and illegally persistently induced or scammed. In order to solve such a problem, a telephone carrier provides an outgoing number notification service that notifies a callee telephone of a caller telephone number (for example, see Japanese Patent Application Laid-open No. 11-177698). According to the outgoing number notification service, a caller telephone number is displayed on a display arranged on a telephone in a telephone call-in state. For this reason, a caller can be specified before the telephone is answered.

However, in an outgoing number notification service offered at the present, for a user who does not want to publish her/his telephone number to the opposite party, in a call-out state, a device which adds a telephone number “184” which is a number to set a call-out mode as a non-notification mode to the front of the number to prevent a callee from being notified of a caller telephone number is employed. For this reason, when a caller sets the call-out mode as a non-notification mode, the caller telephone number is not displayed on a display on the callee side. Consequently, the callee cannot help answering the telephone without specifying a caller.

On the caller side, when a telephone call is made to a shop to make a reservation, or when an emergency contact is desired to be made, a call-out mode may be set as a notification mode to cause a callee to specify the caller. However, if a telephone call is made to a wrong number, caller's own telephone number is in danger of being unintentionally known by the third malevolent party.

### SUMMARY OF THE INVENTION

The present invention has been made in view of the above circumstances and provides a communication apparatus and a communication program storage medium which can specify a caller before answering without being notified of a call-out number of the caller.

A communication apparatus according to the present invention which communicates with an external apparatus by receiving a communication request transmitted from the external apparatus on the basis of a call-out number allocated to the communication apparatus itself in call-out numbers uniquely allocated to apparatuses, includes:

a communication request receiving section which receives a communication request which is allowed to have identification information allocated to the external apparatus independently of a call-out number from the external apparatus;

a display section which displays information;

an information storing section which stores an association table in which the identification information of the external apparatus and apparatus information used for displaying in reception of the communication request from the external apparatus are associated with each other; and

a display control section which, when the communication request receiving section receives a communication request together with identification information, causes the display section to display apparatus information recorded in the association table stored in the information storing section, which is associated with identification information matching the identification information received together with the communication request.

According to the communication apparatus of the present invention, the association table in which the identification information of the external apparatus and the apparatus information used for displaying in reception of a communication request from the external apparatus are associated with each other and stored in advance. When the communication apparatus receives a communication request together with identification information from the external apparatus, the apparatus information associated with the identification information is displayed on the display section. For example, when apparatus information which make it possible to identify a user of the external apparatus is recorded in the association table, even though the communication apparatus is not notified of a call-out number from the external apparatus, the communication apparatus can specify the user of the external apparatus before answering.

The communication apparatus according to the present invention preferably includes:

an information editing section which updates the association table by editing identification information allocated to a non-identifiable external apparatus which transmits a communication request to the communication apparatus without identification information and apparatus information associated with the identification information; and

an identification information transmitting section which transmits the identification information edited for the non-identifiable external apparatus by the information editing section to the non-identifiable external apparatus.

The association table is updated by editing the identification information allocated to the non-identifiable apparatus and the apparatus information, and the allocated identification information is transmitted to the non-identifiable apparatus, so that the communication apparatus can receive a communication request together with the identification information from the non-identifiable external apparatus next time or later and the apparatus information of the non-identifiable external apparatus can be displayed.

The communication apparatus preferably includes:

an own-information storing section which stores identification information allocated to the communication apparatus itself independently of a call-out number; and

a communication request transmitting section which transmits a communication request together with the identification information stored in the own-information storing section to the external apparatus.

In the communication apparatus according to this preferable aspect of the present invention, the external apparatus can be caused to specify the communication apparatus itself without notifying the external apparatus of a call-out number of the communication apparatus itself.

In the communication apparatus according the preferable aspect of the present invention, the own-information storing section stores an association table in which a call-out number of the external apparatus and identification information allocated to the communication apparatus itself by the external apparatus are associated with each other, and the communication request transmitting section transmits a communication request together with the identification Information recorded in the association table stored in the own-information storing section, which is associated with a call-out number matching a call-out number of a communicatee apparatus which transmits a communication request.

The communication apparatus records pieces of identification information allocated by external apparatuses to make it possible to cause the external apparatuses to specify the communication apparatus itself.

In the communication apparatus according to the preferable aspect of the present invention more preferably includes:

an identification information accepting section which accepts identification information allocated to the communication apparatus itself by the external apparatus from the external apparatus; and

an own-information updating section which updates the association table stored in the own-information storing section on the basis of the identification information accepted by the identification information accepting section and the call-out number of the external apparatus.

The communication apparatus accepts allocation of identification information from the external apparatus and updates the association table on the basis of the identification information, so that even an external apparatus which is not recorded on the association table can specify the communication apparatus in next and subsequent call-out operations.

The present invention provides a communication program storage medium which stores a communication program which is executed in a communication apparatus having a function of executing a program and causes the communication apparatus to communicate with an external apparatus by receiving a communication request from the external apparatus on the basis of a call-out number allocated to the communication apparatus itself among call-out numbers uniquely allocated to apparatuses, wherein

the communication apparatus includes:

a communication request receiving section which receives a communication request which is allowed to have identification information allocated to the external apparatus independently of a call-out number from the external apparatus;

a display section which displays information;

an information storing section which stores an association table in which the identification information of the external apparatus and apparatus information used for displaying in reception of the communication request from the external apparatus are associated with each other; and

a display control section which, when the communication request receiving section receives a communication request together with identification information, causes the display section to display apparatus information recorded in the association table stored in the information storing section, which is associated with identification information matching the identification information received together with the communication request.

According to the communication program of the present invention, the communication apparatus can be caused to function as a communication apparatus which can specify a caller before answering without being notified of a call-out number of the caller.

In addition, as for the constituent elements according to the present invention such as the communication request receiving section constructed by the communication program of the present invention, one constituent element may be constructed by one program module, one constituent element is constructed by program modules, or constituent elements may be constructed by one program module. The constituent elements may execute these operations by themselves, or may instruct another program or another program module built in the communication apparatus to execute the operations.

Only the basic configuration of the communication program stored in the communication program storage medium according to the present invention is described to simply avoid overlapping. The communication program stored in the communication program storage medium according to the present invention includes not only the basic configuration but also various configurations corresponding to the various configurations of the communication apparatus.

As described above, according to the present invention, there is provided a communication apparatus and a communication program storage medium which can specify a caller before answering without being notified of a call-out number of the caller.

### BRIEF DESCRIPTION OF THE DRAWINGS

FIG. 1 is a pattern diagram showing an example of a communication system to which an embodiment of the present invention is applied;

FIG. 2 is a perspective diagram of the appearance of a mobile telephone terminal;

FIG. 3 is a block diagram of the hardware of the mobile telephone terminal;

FIG. 4 is a diagram showing functional blocks required to realize a function (information display function) inherent in the embodiment;

FIG. 5 is a diagram showing the configuration of a receiving-association table;

FIG. 6 is a diagram showing the configuration of an outgoing association table;

FIG. 7 is a flow chart showing a flow of processes performed when a fixed telephone terminal makes a telephone call to a mobile telephone terminal in a state in which a destination key information of the fixed telephone terminal is not registered in the mobile telephone terminal; and

FIG. 8 is a flow chart showing a flow of processes performed when the fixed telephone terminal makes a telephone call to the mobile telephone terminal in a state in which the destination key information of the fixed telephone terminal is registered in the mobile telephone terminal.

### DETAILED DESCRIPTION OF THE INVENTION

An embodiment of the present invention will be described below with reference to the accompanying drawings.

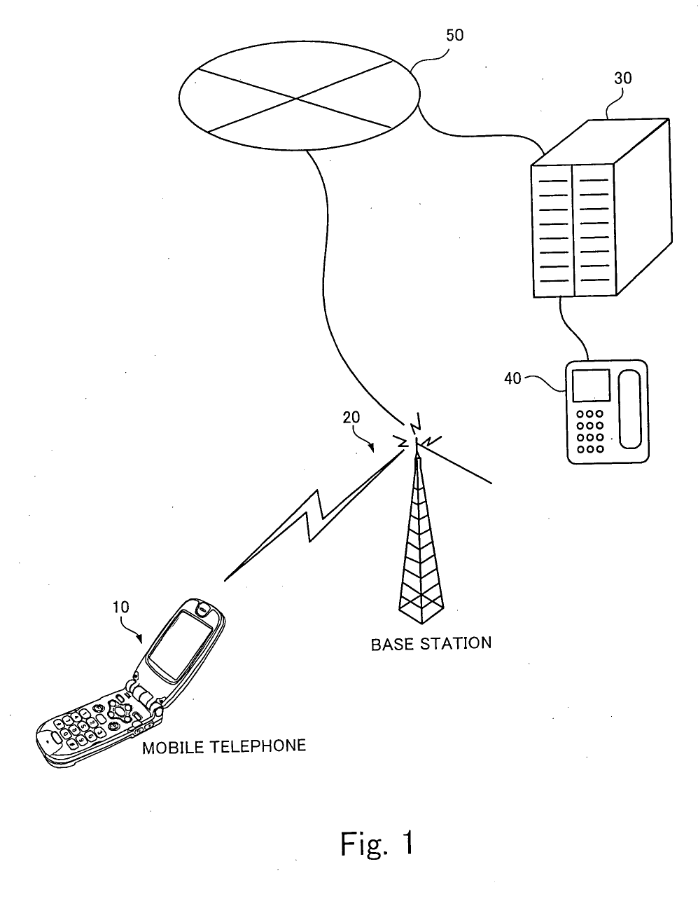

FIG. 1 is a pattern diagram showing an example of a communication system to which an embodiment of the present invention is applied.

FIG. 1 shows a mobile telephone terminal 10, a base station 20 which wirelessly communicates with the mobile telephone terminal 10, a fixed telephone terminal 40, a telephone switchboard 30 which exchanges telephone calls or various pieces of information transmitted from or received by the fixed telephone terminal 40, and a telephone network 50 which connects the telephone switchboard 30 and the base station 20 to each other. Actually, a large number of mobile telephone terminals and fixed telephone terminals are connected to the base station 20 and the telephone switchboard 30, and a large number of base stations, a large number of telephone switchboards, and the like are connected to the telephone network 50. However, in FIG. 1, for simplification of the drawing, only the components necessary for the explanation of the present invention are shown.

In the embodiment, when the mobile telephone terminal 10 and the fixed telephone terminal 40 make telephone calls, any one of a “notification mode” in which a calling terminal notifies a destination terminal of a telephone number of the calling terminal and a “non-notification mode” in which the calling terminal does not notify the destination terminal of the telephone number of the calling terminal can be selected as a call-out mode. For example, when the fixed telephone terminal 40 makes a telephone call to the mobile telephone terminal 10 in the “notification mode”, the mobile telephone terminal 10 is notified of the telephone number of the fixed telephone terminal 40, and the telephone number of the fixed telephone terminal 40 is displayed on an LCD arranged on the mobile telephone terminal 10. A user of the mobile telephone terminal 10 checks the telephone number displayed on the LCD of the mobile telephone terminal 10 to make it possible to specify the caller as a user of the fixed telephone terminal 40. However, when the fixed telephone terminal 40 makes a telephone call to the mobile telephone terminal 10 in the “non-notification mode”, the telephone number of the fixed telephone terminal 40 cannot be displayed because the mobile telephone terminal 10 is not notified of the telephone number of the fixed telephone terminal 40. Each of the mobile telephone terminal 10 and the fixed telephone terminal 40 according to the embodiment has an information display function which can display information to specify a destination terminal on the LCD even though the destination terminal makes a telephone call in the “non-notification mode”. The information display function will be described later in detail.

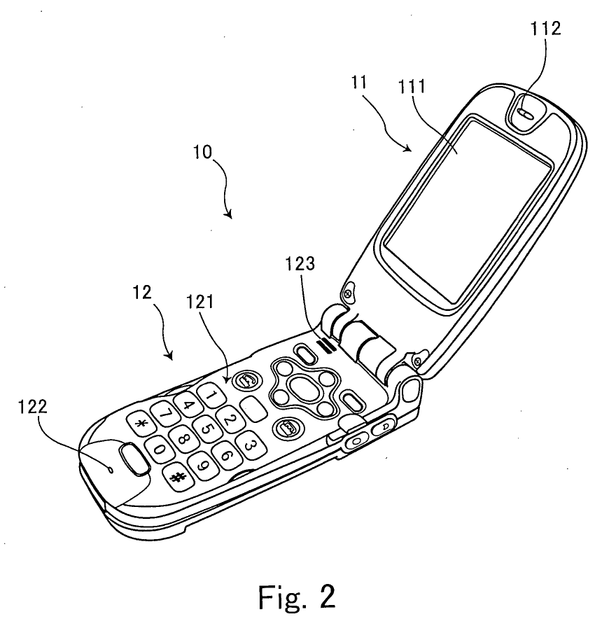

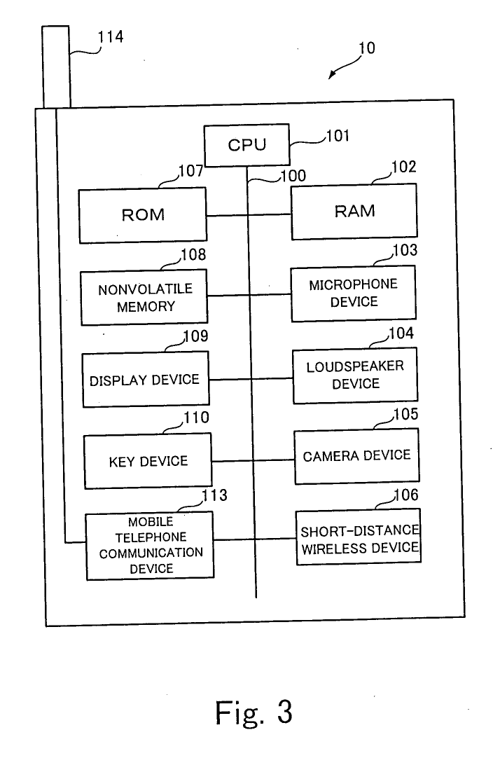

FIG. 2 is a perspective diagram showing the appearance of the mobile telephone terminal, and FIG. 3 is a block diagram showing the hardware of the mobile telephone terminal.

The mobile telephone terminal 10 is constituted by an upper housing 11 and a lower housing 12 which are opened and closed. An LCD 111 to display an image and an earpiece 112 in which a small speaker is mounted and which is put to an ear of a user to cause the user to hear voice are formed on the upper housing 11.

On the lower housing 12, various operation keys 121 which are operated by a user to make a telephone call through the mobile telephone terminal 10, to transmit an electronic mail, and to perform various settings, a mouthpiece 122 in which a microphone to pick up voice of the user is built to guide the voice to the microphone, and loudspeaker holes 123 in which a slightly large loudspeaker is built to output voice loud enough to hear the voice without causing an ear of the user to put the loudspeaker holes 123.

FIG. 3 shows a CPU 101, an RAM 102, a microphone device 103, a loudspeaker device 104, a camera device 105, a short-distance wireless device 106, a ROM 107, a nonvolatile memory 108, a display device 109, a key device 110, a mobile telephone communication device 113, and an antenna 114. The components except for the antenna 114 are connected to each other through a bus 100.

The CPU 101 has functions of executing various programs to control the mobile telephone terminal 10 as a whole.

In the ROM 107, the various programs executed by the CPU 101 and various constants required for execution of the various programs are stored. The CPU 101 executes the programs stored in the ROM 107 while using the RAM 102 as a work area.

In the nonvolatile memory 108, various rewritable setting conditions and the like for the mobile telephone terminal 10 are recorded.

The microphone device 103 includes a microphone which picks up voice of a user and a functional block which processes the voice picked up by the microphone.

The loudspeaker device 104 includes a loudspeaker which outputs voice to a user and a functional block which generates a voice signal to drive the loudspeaker.

The short-distance wireless device 106 is to transmit an image, a telephone number, and the like to an external apparatus without the base station 20, and employs infrared communication or the like.

The camera device 105 is a block which controls collection of image data by photography, the display device 109 is a block which controls image display on the LCD 111 (see FIG. 2), and the key device 110 is a block which detects a key operation for the operation keys 121 (see FIG. 2) by a user.

The mobile telephone communication device 113 performs transmission and reception of telephone calls through the antenna 114, transmission and reception of electronic mails, and the like.

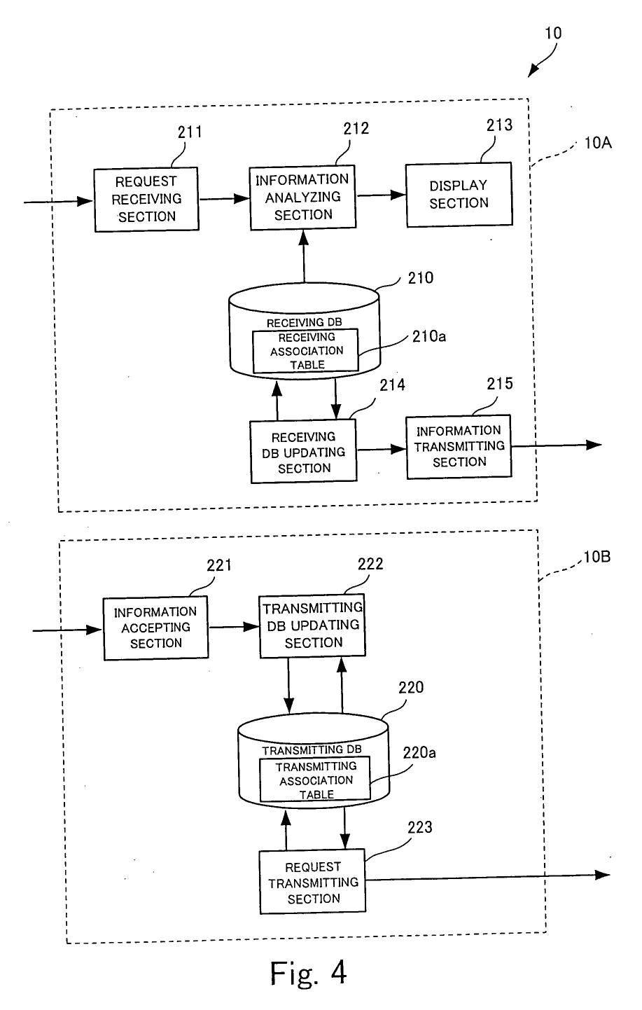

FIG. 4 is a diagram showing functional blocks which are constructed by the composition between the hardware of the mobile telephone terminal 10 and the programs executed by the CPU 101 of the mobile telephone terminal 10 and which are required to realize a function (information display function) inherent in the embodiment.

In FIG. 4, there are shown: a receiving section 10A constituted by a request receiving section 211, an information analyzing section 212, a display section 213, a receiving DB updating section 214, an information transmitting section 215, and a receiving DB 210; and a transmitting section 10B constituted by an information accepting section 221, a transmitting DB updating section 222, a request transmitting section 223, and a transmitting DB 220.

Various elements constituting the receiving section 10A will be described below.

The nonvolatile memory 108 shown in FIG. 3 undertakes the role of the receiving DB 210 storing a receiving association table 210a.

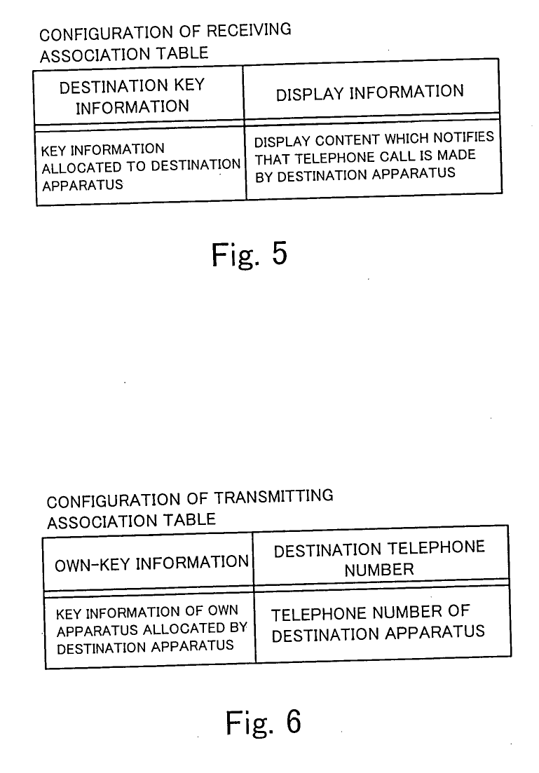

FIG. 5 is a diagram showing the configuration of the receiving association table 210a.

As shown in FIG. 5, the receiving association table 210a is constituted by destination key information representing key information uniquely allocated to a communicatee terminal and display information representing display contents to notify the mobile telephone terminal that the mobile telephone terminal has received a telephone call made by the communicatee terminal.

In the receiving DB 210, the receiving association table 210a having the configuration shown in FIG. 5 is stored. The receiving DB 210 corresponds to an example of the information storing section according to the present invention.

The mobile telephone communication device 113 shown in FIG. 3 undertakes the role of the request receiving section 211. The request receiving section 211 receives a communication request and a call-out mode (notification mode/non-notification mode) transmitted from the fixed telephone terminal 40 or the like shown in FIG. 1. When the call-out mode is a notification mode, a telephone number is transmitted as well. In response to the communication request, the mobile telephone terminal 10 receives a call to set in a response waiting state. When a speaking key (not shown) of the operation keys 121 is selected by a user, the state of the mobile telephone terminal 10 shifts to a speech-communicable state. Key information of the communicatee terminal may be transmitted together with the communication request. In this case, the request receiving section 211 receives the key information. The received key information and the call-out mode information are transmitted to the information analyzing section 212. The request receiving section 211 corresponds to an example of the communication request receiving section according to the present invention.

The information analyzing section 212 searches destination key information in the receiving association table 210a stored in the receiving DB 210 for key information matching the key information transmitted from the request receiving section 211 to acquire display information associated with the searched destination key information. The acquired display information is transmitted to the display section 213. When the key information is not received by the request receiving section 211, the display section 213 is notified that there is no display information. The information analyzing section 212 corresponds to an example of the display control section according to the present invention.

The LCD 111 in FIG. 2 and the display device 109 in FIG. 3 undertake the role of the display section 213. When the transmitted call-out mode information is a notification mode, the telephone number of the communicatee terminal together with the call-out mode information is displayed on the LCD 111. When the call-out mode information is a non-notification mode, it is displayed on the LCD 111 that the “non-notification mode” is set. When display information is transmitted from the information analyzing section 212, the display information is displayed on the LCD 111. When no display information is transmitted to the information analyzing section 212, it is displayed on the LCD 111 that “no display information” is set. The display section 213 corresponds to an example of the display section according to the present invention.

In this case, when no key information is sent from the communicatee terminal, a user of the mobile telephone terminal 10 takes a telephone call to perform speech communication with a user of the communicates terminal. When the user of the communicatee terminal is specified, the registration key of the operation keys 121 is selected. At this time, the receiving DB updating section 214 allocates the unregistered key information to the communicatee terminal. Furthermore, the user edits apparatus information to the communicatee terminal upon completion of the speech communication, the receiving association table 210a is updated on the basis of the edited apparatus information and the key information allocated to the communicatee terminal. The allocated key information is transmitted to the information receiving section 215. The receiving DB updating section 214 corresponds to an example of the information editing section according to the present invention.

The mobile telephone communication device 113 shown in FIG. 3 undertakes the role of the information receiving section 215. The information receiving section 215 transmits the key information transmitted from the receiving DB updating section 214 to the communicatee terminal. The information receiving section 215 corresponds to an example of identification information transmitting section according to the present invention.

The receiving section 10A has the configuration described above. Subsequently, the various elements constituting the transmitting section 10B will be described below.

The nonvolatile memory 108 shown in FIG. 3 undertakes the role of the transmitting DB 220 that stores a transmitting association table 220a.

FIG. 6 is a diagram showing the configuration of the transmitting association table 220a.

As shown in FIG. 6, the transmitting association table 220a is constituted by own-key information representing key terminal of an own-terminal allocated by a communicatee terminal and a telephone number of the communicatee terminal.

The transmitting association table 220a having the configuration shown in FIG. 6 is stored in the transmitting DB 220. The transmitting DB 220 corresponds to an example of the own-information storing section according to the present invention.

When a user of the mobile telephone terminal 10 designates the telephone number of the communicatee terminal by using the operation key 121, the request transmitting section 223 searches destination telephone numbers registered in the transmitting association table 220a for a telephone number matching the telephone number of the communicatee terminal. When there is no coincided destination telephone number, the request transmitting section 223 transmits only a communication request to the communicatee terminal. When there is the coincided destination telephone number, the request transmitting section 223 transmits own-key information associated with the destination telephone number together with the communication request. When a telephone call is made in a “notification mode”, the request transmitting section 223 transmits information of the “notification mode” together with the communication request. When a telephone call is made in a “non-notification mode”, the request transmitting section 223 transmits information of the “non-notification mode” together with the communication request. The request transmitting section 223 corresponds to an example of the communication request transmitting section according to the present invention.

When key information allocated by the communicatee terminal is transmitted during speech communication, the key information is received by the information accepting section 221. The received key information is transmitted to the transmitting DB updating section 222. The information accepting section 221 corresponds to an example of the identification information accepting section according to the present invention.

The transmitting DB updating section 222 updates the transmitting association table 220a on the basis of the key information transmitted from the information accepting section 221 and a telephone number of a communicatee terminal with which the user communicates. The transmitting DB updating section 222 corresponds to an example of the own-information updating section according to the present invention.

The mobile telephone terminal 10 basically has the functions described above.

In this case, the mobile telephone terminal 10 and the fixed telephone terminal 40 are different from each other in appearance, hardware configuration, and communication methods. However, the fixed telephone terminal 40 also has the information display function inherent in the embodiment shown in FIG. 4. The same drawings and reference numerals as those in the fixed telephone terminal 40 are used to explain the same elements and functions constituting the fixed telephone terminal 40 as those in the mobile telephone terminal 10. Processes executed by the fixed telephone terminal 40 and the mobile telephone terminal 10 when the fixed telephone terminal 40 makes a telephone call to the mobile telephone terminal 10 in the “non-notification mode” will be described below.

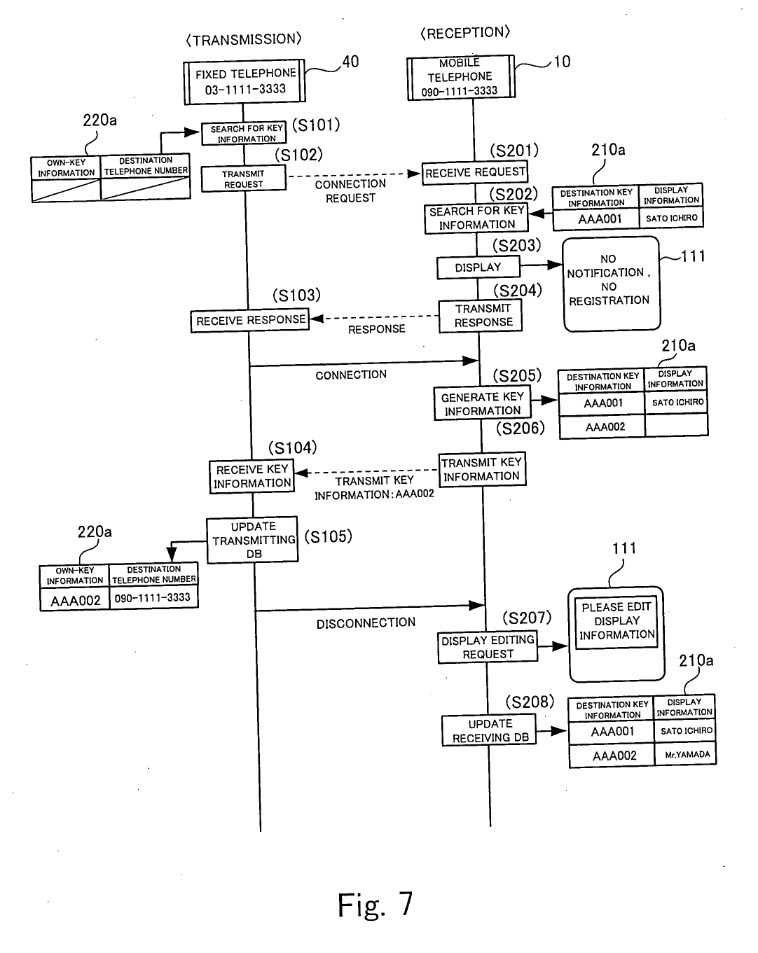

FIG. 7 is a flow chart showing a flow of processes when the fixed telephone terminal 40 makes a telephone call to the mobile telephone terminal 10 in a state in which destination key information of the fixed telephone terminal 40 is not registered in the mobile telephone terminal 10.

A user of the fixed telephone terminal 40 designates a telephone number (090-1111-3333) of the mobile telephone terminal 10 to make a telephone call to the mobile telephone terminal 10. At this time, the request transmitting section 223 of the fixed telephone terminal 40 shown in FIG. 4 searches destination telephone numbers recorded in the transmitting association table 220a for a telephone number matching the telephone number designated by the user (step S101 in FIG. 7). In this example, in the stage of step S101 in FIG. 7, since the destination telephone number is not registered in the transmitting association table 220a, the request transmitting section 223 transmits only a communication request to the mobile telephone terminal 10 without key information (step S102 in FIG. 7).

In the mobile telephone terminal 10, the communication request transmitted from the fixed telephone terminal 40 is received by the request receiving section 211 shown in FIG. 4 (step S201 in FIG. 7). In this example, the request receiving section 211 receives only the communication request without receiving the key information. For this reason, the information analyzing section 212 determines a searching result as “no display information” without searching the receiving association table 210a (step S202 in FIG. 7). Further, the information analyzing section 212 transmits the searching result of “no display information” to the display section 213.

According to the searching result transmitted from the information analyzing section 212, the display section 213 displays a message “no registered” representing that destination key information of the fixed telephone terminal 40 is not registered and a message “non-notification mode” on the LCD 111 is displayed (step S203 in FIG. 7).

A user of the mobile telephone terminal 10 checks the LCD 213 to recognize that a caller whose the destination key information is not registered has made a telephone call in the non-notification mode. When the user takes the telephone call, a response to the communication request is transmitted from the mobile telephone communication device 113 shown in FIG. 3 to the fixed telephone terminal 40 (step S204 in FIG. 7).

The fixed telephone terminal 40 receives the response transmitted from the mobile telephone terminal 10 (step S103 in FIG. 7), the fixed telephone terminal 40 and the mobile telephone terminal 10 are set in a speech-communicable state.

When speech communication between the user of the fixed telephone terminal 40 and the user of the mobile telephone terminal 10 is established to cause the user of the mobile telephone terminal 10 to specify the user of the fixed telephone terminal 40, the user of the mobile telephone terminal 10 selects a registration key of the operation key 121 of the mobile telephone terminal 10 to register key information of the fixed telephone terminal 40.

At this time, the receiving DB updating section 214 of the mobile telephone terminal 10 allocates key information (AAA002) which is not registered in the receiving association table 210a to the fixed telephone terminal 40 (step S205 in FIG. 7). Furthermore, the receiving DB updating section 214 updates the receiving association table 210a on the basis of the allocated key information. In this state, as shown in step S205 in FIG. 7, only the key information (AAA002) of the fixed telephone terminal 40 is registered in the receiving association table 210a of the mobile telephone terminal 10, and no display information is registered in the receiving association table 210a.

The key information allocated by the receiving DB updating section 214 is transmitted from the information transmitting section 215 to the fixed telephone terminal 40 (step S206 in FIG. 7).

In the fixed telephone terminal 40, the information accepting section 221 shown in FIG. 4 acquires key information transmitted from the mobile telephone terminal 10 (step S104 in FIG. 7). The acquired key information is transmitted to the transmitting DB updating section 222.

The transmitting DB updating section 222 of the fixed telephone terminal 40 updates the transmitting association table 220a stored in the transmitting DB 220 of the fixed telephone terminal 40 on the basis of the telephone number (090-1111-3333) of the mobile telephone terminal 10 designated by the user of the fixed telephone terminal 40 and the transmitted key information (AAA002) (step S105 in FIG. 7). As a result, as shown in step S105 in FIG. 7, the key information (AAA002) of the fixed telephone terminal 40 allocated by the mobile telephone terminal 10 and the telephone number (090-1111-3333) are recorded in the transmitting association table 220a of the fixed telephone terminal 40 such that the key information and the telephone number are associated with each other.

Upon completion of the speech communication between the user of the fixed telephone terminal 40 and the user of the mobile telephone terminal 10, the fixed telephone terminal 40 and the mobile telephone terminal 10 are disconnected from each other.

In the mobile telephone terminal 10, as shown in step S205, only the key information (AAA002) of the fixed telephone terminal 40 is registered in the receiving association table 210a, and no display information is registered in the receiving association table 210a. For this reason, an editing request is transmitted to the user. The display section 213 in FIG. 4 displays a message “Please edit display information” on the LCD 111 (step S207 in FIG. 7).

When the user of the mobile telephone terminal 10 edits the display information (Mr. Yamada) of the fixed telephone terminal 40, the receiving DB updating section 214 in FIG. 4 adds the display information edited by the user to a field in which the key information of the fixed telephone terminal 40 is recorded in the receiving association table 210a (step S208 in FIG. 7). As a result, the key information (AAA002) and the display information (Mr. Yamada) of the fixed telephone terminal 40 are registered in the receiving association table 210a.

Subsequently, a case in which the fixed telephone terminal 40 makes a telephone call to the mobile telephone terminal 10 in a state in which destination key information of the mobile telephone terminal 10 is registered will be described below.

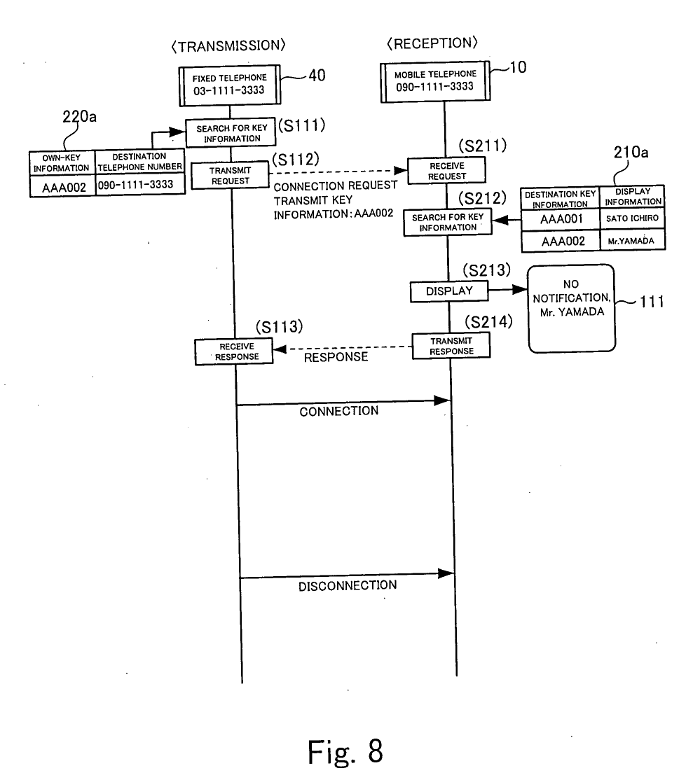

FIG. 8 is a flow chart showing a flow of processes performed when the fixed telephone terminal 40 makes a telephone call to the mobile telephone terminal 10 in the state in which the destination key information of the fixed telephone terminal 40 is registered.

As in FIG. 7, the user of the fixed telephone terminal 40 designates the telephone number (090-1111-3333) of the mobile telephone terminal 10 to make a telephone call to the mobile telephone terminal 10. The request transmitting section 223 of the fixed telephone terminal 40 shown in FIG. 4, as in step S101 in FIG. 7, searches destination telephone numbers recorded in the transmitting association table 220a for a telephone number matching the telephone number designated by the user (step S111 in FIG. 8). In this example, since the telephone number (090-1111-3333) of the mobile telephone terminal 10 is registered in the transmitting association table 220a of the fixed telephone terminal 40, own-key information (AAA002) associated with the telephone number is acquired. The request transmitting section 223 transmits the communication request and the own-key information to the mobile telephone terminal 10 (step S112 in FIG. 8).

In the mobile telephone terminal 10, the communication request and the key information transmitted from the fixed telephone terminal 40 are received by the request receiving section 211 (step S211 in FIG. 8).

The information analyzing section 212 of the mobile telephone terminal 10 searches the destination key information recorded in the receiving association table 210a for information matching the key information (AAA002) transmitted from the fixed telephone terminal 40 to acquire the display information (Mr. Yamada) associated with the destination key information (step S212 in FIG. 8). The information analyzing section 212 transmits the acquired display information to the display section 213.

The display section 213 displays the display information (Mr. Yamada) transmitted from the information analyzing section 212 and a message “non-notification mode” on the LCD 111 (step S213 in FIG. 8).

The user of the mobile telephone terminal 10 can find that a telephone call is made by “Mr. Yamada” before answering by checking the LCD 111.

When the user takes a telephone call, a response to the communication request is transmitted from the mobile telephone communication device 113 shown in FIG. 3 to the fixed telephone terminal 40 (step S214 in FIG. 8), and the fixed telephone terminal 40 receives the response transmitted from the mobile telephone terminal 10 (step S113 in FIG. 8). The fixed telephone terminal 40 and the mobile telephone terminal 10 are set in a speech-communicable state. Upon completion of the speech communication, the fixed telephone terminal 40 and the mobile telephone terminal 10 are disconnected from each other.

In this manner, according to the embodiment, even if a user gets a telephone call in a non-notification mode, the user can specify the caller before answering. Furthermore, even though the user makes a telephone call, the telephone number of his/her own terminal can be avoided from being disadvantageously known by a wrong callee, and the terminal can be specified by a correct callee.

The above-described example is an example in which the present invention Is applied to a mobile telephone using wireless communication or a fixed telephone which performs speech communication with a telephone line. However, the communication apparatus of the present invention may also be applied to an internet telephone which performs speech communication through the Internet.

What is claimed is:

1. A communication apparatus which communicates with an external apparatus by receiving a communication request transmitted from the external apparatus on the basis of a call-out number allocated to the communication apparatus itself among call-out numbers uniquely allocated to apparatuses, comprising:
a communication request receiving section which receives a communication request which is allowed to have identification information allocated to the external apparatus independently of a call-out number from the external apparatus;
a display section which displays information;
an information storing section which stores an association table in which the identification information of the external apparatus and apparatus information used for displaying in reception of the communication request from the external apparatus are associated with each other; and
a display control section which, when the communication request receiving section receives a communication request together with identification information, causes the display section to display apparatus information recorded in the association table stored in the information storing section, which is associated with identification information matching the identification information received together with the communication request.

2. The communication apparatus according to claim 1, further comprising:
an information editing section which updates the association table by editing identification information allocated to a non-identifiable external apparatus which transmits a communication request to the communication apparatus without identification information and apparatus information associated with the identification information; and
an identification information transmitting section which transmits the identification information edited for the non-identifiable external apparatus by the information editing section to the non-identifiable external apparatus.

3. The communication apparatus according to claim 1, further comprising:
an own-information storing section which stores identification information allocated to the communication apparatus itself independently of a call-out number; and
a communication request transmitting section which transmits a communication request together with the identification information stored in the own-information storing section to the external apparatus.

4. The communication apparatus according to claim 3, wherein the own-information storing section stores an association table in which a call-out number of the external apparatus and identification information allocated to the communication apparatus itself by the external apparatus are associated with each other, and
the communication request transmitting section transmits a communication request together with the identification information recorded in the association table stored in the own-information storing section, which is associated with a call-out number matching a call-out number of a communicates apparatus which transmits a communication request.

5. The communication apparatus according to claim 4, further comprising:
an identification information accepting section which accepts identification information allocated to the communication apparatus itself by the external apparatus from the external apparatus; and
an own-information updating section which updates the association table stored in the own-information storing section on the basis of the identification information accepted by the identification information accepting section and the call-out number of the external apparatus.

6. A communication program storage medium which stores a communication program which is executed in a communication apparatus having a function of executing a program and causes the communication apparatus to communicate with an external apparatus by receiving a communication request from the external apparatus on the basis of a call-out number allocated to the communication apparatus itself among call-out numbers uniquely allocated to apparatuses, wherein
the communication apparatus comprises:
a communication request receiving section which receives a communication request which is allowed to have identification information allocated to the external apparatus independently of a call-out number from the external apparatus;
a display section which displays information;
an information storing section which stores an association table in which the identification information of the external apparatus and apparatus information used for displaying in reception of the communication request from the external apparatus are associated with each other; and
a display control section which, when the communication request receiving section receives a communication request together with identification information, causes the display section to display apparatus information recorded in the association table stored in the information storing section, which is associated with identification information matching the identification information received together with the communication request.
